(19) United States
(12) Patent Application Publication
(10) Pub. No.: US 2023/0203880 A1
(43) Pub. Date: Jun. 29, 2023

(54) KIT FOR A FRAME AND PROFILE CONNECTORS

(71) Applicant: Arnd Büdenbender, Netphen-Deuz (DE)

(72) Inventors: Arnd Büdenbender, Netphen-Deuz (DE); Ritske Johannes van Leeuwen, Koedijk (NL)

(21) Appl. No.: 18/085,510

(22) Filed: Dec. 20, 2022

(30) Foreign Application Priority Data
Dec. 23, 2021 (DE) 102021134511.1

(51) Int. Cl. E06B 9/52

(52) U.S. Cl. CPC E06B 9/522

(57) ABSTRACT

The present invention relates to a kit (3) for a frame, in particular for a frame of an insect protective device, with a first preassembled frame unit (1) and a second preassembled frame unit (2), wherein the two frame units (1, 2) in each case have a first free profile strip (1.1, 2.1), a second free profile strip (1.2, 2.2), and a connecting device (1.3, 2.3) having at least one further profile strip (1.3a, 1.3b, 2.3a, 2.3b). The invention also relates to profile connectors (5) for such a kit (3).

The present invention relates to a kit for a frame and, in particular, to a kit for a frame of an (insect) protective device. On such a frame of a protective device, an (insect, pollen, and/or sun) protective screen is usually attached, which spans the opening defined by the frame. The protective device can then be mounted on a frame (in particular a window frame or door frame) of a building opening (in particular a window or door).

A kit for a frame of an insect protective device is of known art, for example, from EP 3 835 539 A1, wherein the kit comprises four frame units and wherein each frame unit has an inner profile strip and an outer profile strip, which are connected to one another by way of a corner connector comprising an axis of rotation. In an as-delivered state, the inner profile strips and the outer profile strips of the four frame units are in each case aligned parallel to one another. The end user must unfold each of the frame units delivered in this way about the axis of rotation of the corner connector, so that the inner profile strip and the outer profile strip are arranged at a 90° angle to one another. The end user then has to align the profile strips of the frame units relative to one another and push them into one another, such that the frame is formed, wherein the inner profile strip of one frame unit can be telescoped into the outer profile strip of an adjacent frame unit. In this manner, the frame can easily be adapted to windows of different sizes. A frame consisting of four frame units is also of known art from U.S. Pat. No. 4,279,288 A. Even though such kits make assembly much easier for the end user, the presence of four frame units means that he has to assemble a large number of frame units.

Thus EP 3 835 539 A1 also discloses a kit consisting of just two frame units, each of which can be brought into a right-angled position for purposes of assembly. However, these frame units have a push-in connection at the free ends in the region of the corner connectors. At the free ends of these frame units, other corner connector components than such corner connector components are therefore necessary for the formation of a pivot joint within a frame unit. A higher number of different components is therefore required to provide such a kit with just two frame units.

A solution is of known art in each case from EP 3 690 177 A1 and EP 3 910 155 A1, as to how a foldable corner connector in its unfolded position can be protected against any inadvertent folding back. Thus EP 3 690 177 A1 provides a separate fixing element, which, in the unfolded assembly position, can be inserted into both connecting legs of a corner connector. EP 3 910 155 A1 proposes that the corner connector has a clamping design. onto which an attachment device can be clipped. However, there is also the desire that the fixing element, which, in accordance with EP 3 690 177 A1, can be designed as a clip-on element, is itself secured against any inadvertent release.

In addition, for such frames it is of known art for a seal in the form of a brush seal, for example, to be attached all around the frame, so that the frame is sealed against a window frame. Here, too, it is desirable if the seal is better secured against any inadvertent release.

It is therefore the object of the present invention to eliminate the disadvantages described with reference to the prior art, and, in particular, to specify a kit that is even easier for an end user to assemble, and, furthermore, to specify profile connectors in which the components mounted on the profile connector are secured against any inadvertent release.

A solution to the object is specified by a kit with the features of claim 1, and by profile connectors with the respective features of claims 10 and 14. Other solutions and advantageous developments of the kit and the profile connectors are specified in the dependent claims and in the description, wherein individual features of the description and the dependent claims can be combined with one another in a technically reasonable manner.

In particular the object is achieved by a kit for a frame, and in particular by a kit for a frame of an insect protective device. The kit comprises a first pre-assembled frame unit and a second pre-assembled frame unit. Each of the two frame units comprises in each case a first free profile strip, a second free profile strip, and a connecting device, which has at least one further profile strip. The first free profile strip is connected to the connecting device at a first end of the connecting device by way of a first pivot joint having an axis of rotation. The second free profile strip is connected to the connecting device at a second end of the connecting device by way of a second pivot joint having an axis of rotation. The two pivot joints of each frame unit are designed such that, in an initial position, the two free profile strips and the connecting device are aligned parallel to one another, and in that the free profile strips can be translated to an assembly position, in which the frame unit is U-shaped, by pivoting to the connecting device about the respective axis of rotation. In the assembly position, in which the two frame units are U-shaped, the free profile strips of the first frame unit and the free profile strips of the second frame unit can be telescopically pushed into one another.

In other words, the basic concept of the invention is that just two modules (a first pre-assembled frame unit and a second pre-assembled frame unit) are provided to the end user for the assembly of the frame, which modules the end user can bring into a U-shaped position by unfolding the free profile strips, in which position the free profile strips of the two modules can be pushed into one another. The essentially parallel alignment of the free profile strip with the connecting device in the initial position thus ensures, on the one hand, that the kit can be provided to the end customer in a compact form in a container (packaging), while the end customer has less assembly work. Insofar as the free profile strips are arranged in the assembly position essentially in a plane defined together with the connecting device, it may well be that in the initial position the free profile strips are arranged orthogonal to the plane, offset from one another and directly next to one another, which is still to be understood as parallel.

In principle, it would be conceivable for the at least one axis of rotation to be aligned in the plane spanned by the frame and at approximately a 45° angle to the direction in which the free profile strip extends. Preferably, however, the axes of rotation of the pivot joints of both frame units are aligned parallel to one another (in the assembled state of the frame) and orthogonal to a plane spanned by the frame. In this form of embodiment, also during the translation from the initial position to the assembly position, the free profile strips are arranged in the plane that is defined by the free profile strips and the connecting device in the assembly position. In the latter form of embodiment, a particularly stable connection of the free profile strips with the connecting device is possible in the assembly position.

In a preferred form of embodiment, the (free) profile strips are designed as an inner profile strip or as an outer profile strip, wherein in the assembly position the inner profile strip of one frame unit can be inserted into the outer profile strip of the other frame unit. Thus, for example, it would be possible for the free profile strips of the first frame unit to be designed as inner profile strips, and the free profile strips of the second frame unit to be designed as outer profile strips. However, provision can also be made for the two frame units in each case to have an outer profile strip and an inner profile strip as free profile strips.

In the simplest case, the profile strips can be designed as tubes (with a circular or an angular cross-section) that can be pushed into one another. However, it is preferable for the profile strips to have at least one contour, extending along their longitudinal extent, which enables the attachment of a seal and/or a protective screen. In particular, therefore, a groove extending in the direction of the longitudinal extent of the profile strip can be provided for the reception of a (brush) seal. In addition, a contour projection or recess that extends along the longitudinal extent of the profile strip can be provided, to which an (insect) protective screen can be fixed, if necessary, by means of further components (such as a fixing strip).

The outer contour of the inner profile strip is matched to the inner contour of the outer profile strip, such that they can be telescopically pushed into one another.

In the initial position, the free profile strips of the frame unit are preferably arranged essentially parallel to one another, but offset from one another, and offset from the connecting device. Thus, the free profile strips of a frame unit can be arranged offset from one another, orthogonal to the plane, and on the same side of the connecting device. Although the free profile strips are arranged in a plane in the assembly position, they can thus be arranged in the initial position directly next to one another (in an orthogonal direction to the plane) by means of slight bracing.

In principle, it is possible for the connecting device to be unalterable in its length. In this case, the frame could be adjustable in size in one direction only. However, it is preferable if the connecting device of a frame unit comprises at least one inner profile strip and at least one outer profile strip. In this manner, the frame in its plane is adjustable in size in two mutually orthogonal directions.

In principle, it is possible for the pivot joint having the axis of rotation to be designed in one piece with a profile strip. However, it is preferable for the pivot joint to be designed as an independent component, namely as a profile connector. In this case, the first profile strip and the second profile strip are each connected to the connecting device by way of a profile connector forming the pivot joint. In this context, provision can be made for a first connecting leg of a profile connector to be inserted into a free profile strip, and for a second connecting leg of the profile connector, which can be pivoted about the axis of rotation relative to the first connecting leg, to be inserted into a profile strip of the connecting device. The configuration of specific profile connectors, which are also provided as corner connectors for purposes of connecting just two profile strips, is described further below.

Provision can also be made for the two frame units in each case to be secured in their assembly position by a fixing. For example, the frame units can have, in the region of the pivot joint, latches that engage with one another in the assembly position, so that any inadvertent pivoting back is prevented. The fixing can alternatively or additionally be implemented in terms of a separate fixing element, which secures the pivot joint in its unfolded position against any inadvertent pivoting back.

Since the present invention aims at providing the kit in a compact manner while simplifying the assembly, it is proposed that the kit comprises packaging (e.g. a carton), in which the two frame units are arranged in their initial position. Needless to say, other components of the kit, such as fixing elements, suspension elements and/or insect protective screens, can also be arranged in the packaging.

The invention also relates to a profile connector for a frame, and in particular for a frame unit of the kit described above. The profile connector comprises at least a first connecting leg, in particular one that can be inserted into a profile strip, and a second connecting leg, in particular one that can be inserted into a profile strip. The profile connector also comprises a pivot joint having at least one axis of rotation between the first connecting leg and the second connecting leg, which pivot joint is designed such that the first connecting leg and the second connecting leg can be translated from an initial position by a relative pivot movement about the at least one axis of rotation into an assembly position, in which the first connecting leg and the second connecting leg are arranged at right angles to one another in a plane.

In a first aspect relating to the profile connector provision is made for the profile connector to comprise a functional element (such as a suspension element), wherein at least the first connecting leg has a receptacle for the functional element, and the receptacle is arranged such that the functional element can be inserted into the receptacle in the initial position, and for the functional element, inserted into the receptacle, to be secured against removal from the receptacle by the second connecting leg in the assembly position.

In another aspect relating to the profile connector, provision is made for at least one connector leg to have an end receptacle for receiving an end of a seal, wherein the end receptacle extends into the plane.

In both aspects relating to the profile connector, provision is made for an additional component (a functional element or seal) to be secured against any inadvertent release by the fact that the connecting legs can be pivoted towards one another, and the fact that in the assembly position the additional component is secured.

In particular, the profile connector has a connecting leg, which can be at least partially inserted into a previously described profile strip, in particular in a force-fit manner. The outer profile of the section of the connecting leg that can be inserted into the profile strip is thus matched to the inner profile of the corresponding profile strip.

In particular, in the part protruding beyond the profile strip, the profile connector has the at least one axis of rotation to form the pivot joint. If the movement of the connector legs from the initial position into the assembly position takes place in the plane defined by the assembly position, just one axis of rotation is preferably formed.

If the profile connector has just two connecting legs that can be brought into right angles to one another, this is also referred to as a corner connector. However, it is also possible for the profile connector to have three connecting legs, in which case each connecting leg is arranged at right angles to at least one other connecting leg in the assembly position. Such a profile connector can be used, for example, to form a frame for an insect protective door.

In the region that cannot be inserted into a profile strip, the at least one connecting leg has, in particular, a receiving groove for a seal, which in the assembled state (that is to say, in a state inserted into a profile strip) adjoins a corresponding groove designed in the profile strip, so that the seal can be guided continuously from the profile strip into the profile connector.

The end receptacle, which preferably adjoins the receiving groove, can be designed in a side of a connecting leg, which is to be understood to be an end face, at least in the initial position. The end receptacle is thus designed such that one end of the seal can be inserted into the end receptacle, wherein, in the state inserted into the end receptacle, the end of the seal is aligned approximately at right angles to the section of the seal arranged outside the end receptacle. The end receptacle thus has an opening, in particular on the surface of the connecting leg facing the window frame in the installed state, through which the end of the seal can be inserted into the end receptacle. The end receptacle is in particular arranged on the associated connecting leg such that in the initial position the end receptacle is accessible from the corresponding end face, and in the assembly position is covered by the other connecting leg, wherein in particular the other connecting leg can have a locking element, with which in the assembly position the end of the seal is fixed in the end receptacle. In addition to the aforementioned opening, the end receptacle also has an opening on the end face, through which, in the assembly position, a locking element of the other connecting leg (for example a projection on the other connecting leg) passes. The end receptacle can thus be designed as a kind of groove in the end face of the connecting leg.

Similarly, the receptacle for the functional element is also arranged such that the functional element can be inserted into the receptacle in the initial position.

For this purpose, the receptacle is designed in the initial position on an accessible end face of the connecting leg, which end face, in the assembly position, is covered by the other connecting leg. In this respect, the functional element, which is inserted into the receptacle in the initial position, is secured by the other connecting leg in the assembly position.

The functional element can be designed, for example, as a suspension element, which preferably has an insertion section that can be inserted into the receptacle, a connection section arranged at right angles thereto, and an overlapping section that engages behind the window frame (in the position in which the frame is installed on the window) and is designed at right angles to the connection section and parallel to the insertion section.

The profile connector can be designed such that the functional element can still be moved in the assembly position, in that the functional element can be moved backwards and forwards in the receptacle.

It is also preferable for a receptacle to be designed in each connecting leg. The end user can thus decide, in which of the connecting legs the functional element is to be inserted, depending on the desired orientation of the frame in its installed position.

The invention and the technical environment are explained in what follows by way of example with the aid of the figures. The figures show schematically:

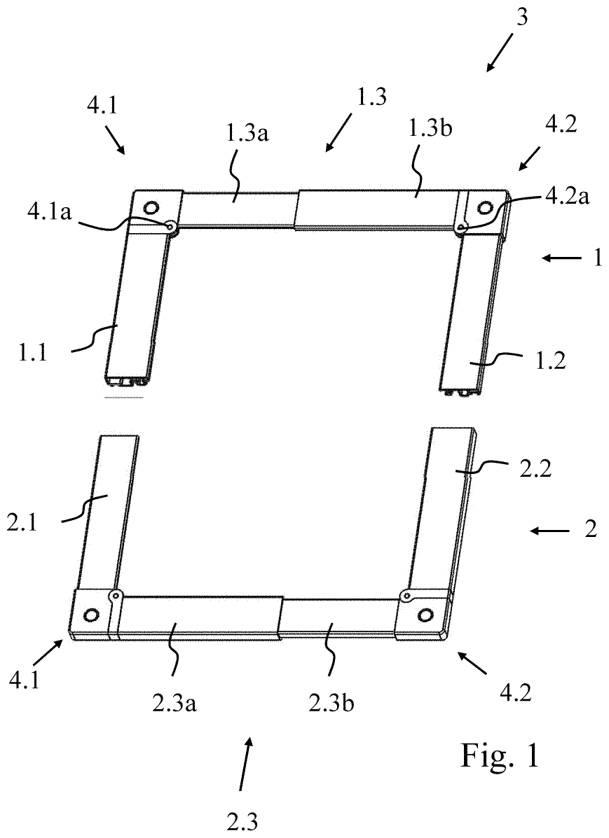

FIG. 1: Two frame units in their assembly position,

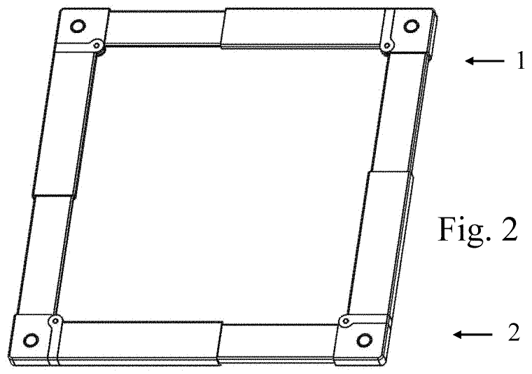

FIG. 2: The two frame units in a pushed into one another state,

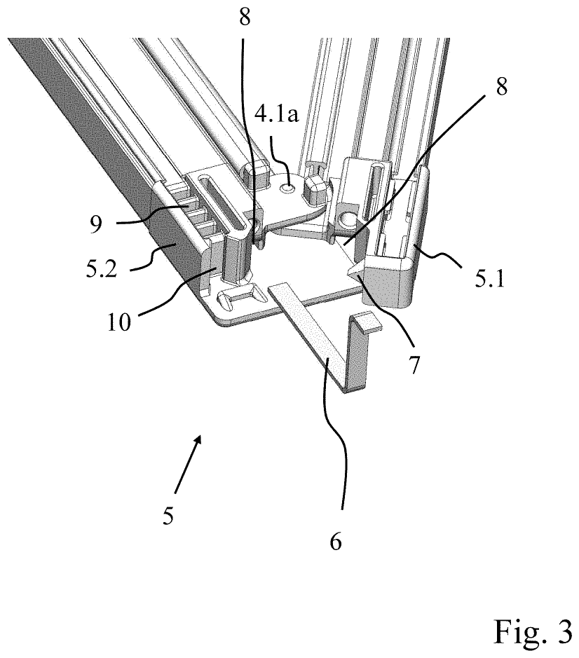

FIG. 3: A profile connector designed as a corner connector in a first position with a functional element,

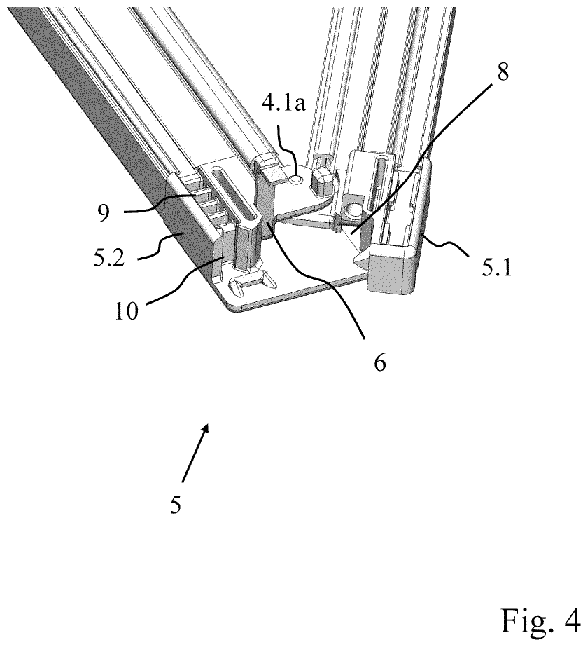

FIG. 4: The corner connector with a functional element inserted into a connecting leg of the corner connector, and

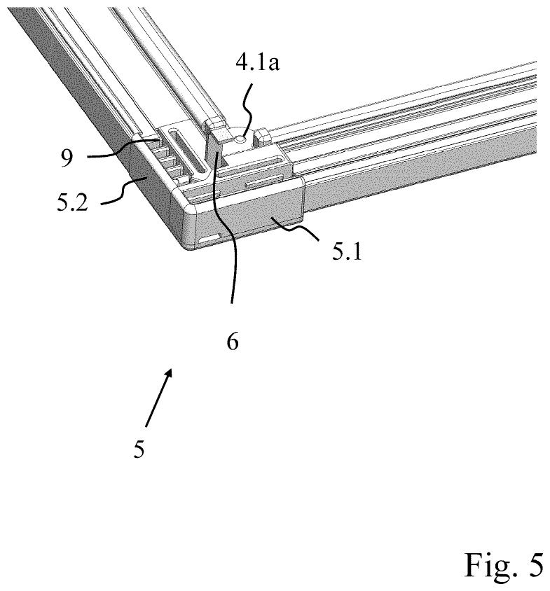

FIG. 5: The corner connector with the inserted functional element in the assembly position.

The kit 3 for a frame shown in FIGS. 1 and 2 comprises a first frame unit 1 and a second frame unit 2. The first frame unit 1 comprises a first free profile strip 1.1, a second free profile strip 1.2, and a connecting device 1.3 formed by two profile strips 1.3a and 1.3b.

The second frame unit 2 comprises a first free profile strip 2.1, a second free profile strip 2.2, as well as a connecting device 2.3 formed by two profile strips 2.3a and 2.3b.

The first free profile strips 1.1 and 2.1 are each connected to the connecting device 1.3, 2.3 by way of a first pivot joint 4.1 having an axis of rotation 4.1a. The second profile strips 1.2 and 2.2 are each connected to the respective connecting device 1.3, 2.3 by way of a second pivot joint 4.2 having an axis of rotation 4.2a.

FIG. 1 shows the frame units 1 and 2 in their respective assembly positions. In these assembly positions, the frame units 1 and 2 are essentially U-shaped.

From the state shown in FIG. 1, it is easy to create a frame, as shown in FIG. 2. To this end, the free profile strips 1.1, 1.2, 2.1 and 2.2 of the frame units 1 and 2 only have to be telescopically pushed into one another.

In the state shown in FIG. 2, the frame spans a plane. The axes of rotation 4.1a and 4.2a are aligned orthogonal to this plane. In this respect, the free profile strips 1.1, 1.2, 2.1 and 2.2 can also be folded from the position shown in FIG. 1 in the direction of the connecting device 1.3 or 2.3 respectively, in which case all profile strips are aligned approximately parallel to one another. In this initial position so defined, the frame units 1, 2 can be provided simply and compactly in a package.

FIGS. 3 to 5 show a profile connector 5 designed as a corner connector, which can also be used in the frame units of FIGS. 1 and 2. The profile connector 5 has a first connecting leg 5.1 and a second connecting leg 5.2, each of which can be inserted in sections into a profile strip. An axis of rotation 4.1a is designed between the first connecting leg 5.1 and the second connecting leg 5.2, so that the connecting legs 5.1, 5.2 can be pivoted from an initial position, in which the connecting legs 5.1, 5.2 or the profile strips are aligned approximately parallel to one another, into an assembly position in which the connecting legs 5.1, 5.2 or the profile strips are arranged at right angles to one another. In FIGS. 3 and 4, the connecting legs 5.1 and 5.2 are in an intermediate position between the initial position and the assembly position.

FIGS. 3 to 5 show on the one hand that the second connecting leg 5.2 has a receiving groove 9, which adjoins a receiving groove of the profile strip. In addition, the second connecting leg 5.2 has an end receptacle 10, which merges into the receiving groove 9. The end receptacle 10 therefore adjoins the receiving groove 9. It is now possible to insert a seal, starting from the receiving groove of the profile connector, into the receiving groove 9 of the connecting leg 5.2, wherein one end of the seal can be inserted into the end receptacle 10. In the installed state, the end of the seal arranged in the end receptacle 10 is thus angled towards the section of the seal arranged in the receiving groove 9. In the assembly position of the profile connector 5, the end receptacle 10 is not accessible, as it is covered by the first connecting leg 5.1. Instead, the first connecting leg 5.1 comprises a locking element 7 in the form of a projection, which engages in the end receptacle 10 in the assembly position shown in FIG. 5, and thus fixes the end of the seal in the end receptacle 10.

It can also be seen from FIGS. 3 to 5 that a functional element 6 designed as a suspension element can be inserted into a receptacle 8 in the first connecting leg 5.1, or into a receptacle 8 in the second connecting leg 5.2. The receptacle 8 is arranged in each case at a front end of the connecting leg 5.1 or 5.2, so that the receptacles 8 are accessible in the initial position (or a slightly pivoted state) of the profile connector 5. In this state, the functional element 6 can be inserted into the receptacle 8 (see FIGS. 3 and 4). The end user can therefore decide in which of the two receptacles 8 he wants to mount the functional element 6, depending on the installation orientation of the frame.

In the assembly position shown in FIG. 5, in which the two connecting legs 5.1 and 5.2 are pivoted about the axis of rotation 4.1a, the functional element 6 cannot be detached from the profile connector 5, since the functional element 6 is prevented from moving out of the receptacle 8 by the first connecting leg 5.1.

### LIST OF REFERENCE SYMBOLS

1 First frame unit
1.1 First free profile strip
1.2 Second free profile strip
1.3 Connecting device
1.3a Profile strip
1.3b Profile strip
2 Second frame unit
2.1 First free profile strip
2.2 Second free profile strip
2.3 Connecting device
2.3a Profile strip
2.3b Profile strip
3 Kit
4.1 First pivot joint
4.1a Axis of rotation
4.2 Second pivot joint
4.2a Axis of rotation
5 Profile connector
5.1 First connecting leg
5.2 Second connecting leg
6 Functional element
7 Locking element
8 Receptacle
9 Receiving groove
10 End receptacle

1. A kit (3) for a frame, in particular for a frame of an insect protective device, with a first preassembled frame unit (1) and a second preassembled frame unit (2), wherein the two frame units (1, 2) in each case comprise:
a first free profile strip (1.1, 2.1),
a second free profile strip (1.2, 2.2), and
a connecting device (1.3, 2.3) having at least one further profile strip (1.3a, 1.3b, 2.3a, 2.3b), wherein
the first free profile strip (1.1, 2.1) is connected to the connecting device (1.3, 2.3) at a first end of the connecting device (1.3, 2.3), by way of a first pivot joint (4.1) having a first axis of rotation (4.1a),
the second free profile strip (1.2, 2.2) is connected to the connecting device (1.3, 2.3) at a second end of the connecting device (1.3, 2.3), by way of a second pivot joint (4.2) having a second axis of rotation (4.2 a), and
the pivot joints (4.1, 4.2) are designed such that:
in an initial position the two free profile strips (1.1, 1.2, 2.1, 2.2) and the connecting device (1.3, 2.3) are aligned parallel to one another, and
the two free profile strips (1.1, 1.2, 2.1, 2.2), by pivoting relative to the connecting device (1.3, 2.3) about the respective axes of rotation (4.1a, 4.2a), are translatable into an assembly position, in which the frame unit (1, 2) is U-shaped, wherein the free profile strips (1.1, 1.2) of the first frame unit (1) and the free profile strips (2.1, 2.2) of the second frame unit (2) in the assembly position are telescopically pushable into one another.

2. The kit (3) according to claim 1, wherein, in the assembly position of the frame, the axes of rotation (4.1a, 4.2a) of both frame units (1, 2) are aligned parallel to one another, and orthogonal to a plane spanned by the frame.

3. The kit (3) according to claim 1, wherein the free profile strips (1.1, 1.2, 2.1, 2.2) are designed as an inner profile strip (1.2, 2.1) or an outer profile strip (1.1, 2.2), wherein in the assembly position the inner profile strip of one frame unit is pushable into the outer profile strip of the other frame unit.

4. The kit (3) according to claim 1, wherein the free profile strips (1.1, 1.2, 2.1, 2.2) of the frame unit (1, 2) in the initial position are arranged parallel to and offset from one another and from the connecting device (1.3, 2.3).

5. The kit (3) according to claim 1, wherein the connecting device (1.3, 2.3) of at least one of the first frame unit or the second frame unit (1, 2) comprises at least one inner profile strip (1.3a, 2.3b) and at least one outer profile strip (1.3b, 2.3a).

6. The kit (3) according to claim 1, wherein the first free profile strip (1.1) and the second free profile strip (1.2) are in each case connected to the connecting device (1.3, 2.3) by way of a profile connector (5) having one of the first pivot joint (4.1) or the second pivot joint (4.2).

7. The kit (3) according to claim 6, wherein a first connecting leg (5.1) of the profile connector (5) is inserted into a free profile strip and a second connecting leg (5.2) of the profile connector (5), which is pivotable relative to the first connecting leg (5.1) about the first axis of rotation (4.1a), is inserted into a profile strip of the connecting device (1.3, 2.3).

8. The kit (3) according to claim 1, wherein the first frame unit (1) and the second frame unit (2) are secured in the assembly position by a fixing.

9. The kit (3) according to claim 1, further comprising a package, in which the first frame unit (1) and the second frame unit (2) are arranged in their initial position.

10. A profile connector (5), in particular for a frame, comprising at least:
a first connecting leg (5.1), which is insertable into a first profile strip,
a second connecting leg (5.2), which is insertable into a second profile strip, and
a functional element (6), wherein
a pivot joint having at least one axis of rotation (4.1a) is designed between the first connecting leg (5.1) and the second connecting leg (5.2), so that the first connecting leg (5.1) and the second connecting leg (5.2) are translatable from an initial position by a relative pivoting movement about the at least one axis of rotation (4.1a) into an assembly position, in which the first connecting leg (5.1) and the second connecting leg (5.2) are arranged in a plane at a right angle to one another, and
at least the first connecting leg (5.1) has a receptacle (8) for the functional element (6), wherein the receptacle (8) is arranged such that the functional element (6) in the initial position is insertable into the receptacle (8), and the functional element (6), inserted into the receptacle (8), in the assembly position is secured against a removal from the receptacle (8) by the second connecting leg (5.2).

11. The profile connector (5) according to claim 10, wherein the functional element is designed as a suspension element.

12. The profile connector (5) according to claim 10, wherein a receptacle (8) for the functional element (6) is designed in both the first connecting leg (5.1) and the second connecting leg (5.2).

13. A profile connector (5), in particular for a frame, comprising at least:
a first connecting leg (5.1) that is insertable into a first profile strip, and
a second connecting leg (5.2) that is insertable into a second profile strip, wherein
a pivot joint having at least one axis of rotation (4.1a) is designed between the first connecting leg (5.1) and the second connecting leg (5.2), so that the first connecting leg (5.1) and the second connecting leg (5.2) are translatable from an initial position by a relative pivoting movement about the at least one axis of rotation (4.1a) into an assembly position, in which the first connecting leg (5.1) and the second connecting leg (5.2) are arranged in a plane at right angle to one another, and
at least one connecting leg (5.2) has an end receptacle (10) for the reception of one end of a seal, wherein the end receptacle (10) extends into the plane.

14. The profile connector (5) according to claim 13, wherein the end receptacle (10) in the initial position is accessible from one end face of the second connecting leg (5.2), and in the assembly position is covered by the first connecting leg (5.1), wherein the first connecting leg (5.1) has a locking element (11), with which, in the assembly position, the end of the seal is fixed in the end receptacle (10).

15. The profile connector (5) according to claim 13, wherein at least one of the first connecting leg (5.1) or the second connecting leg (5.2) has a receiving groove (9) for the seal, wherein the receiving groove (9) runs parallel to the plane, and wherein the end receptacle (10) adjoins the receiving groove (9).
